(19) United States
(12) Patent Application Publication
(10) Pub. No.: US 2024/0429697 A1
(43) Pub. Date: Dec. 26, 2024

(54) OVERCURRENT PROTECTION CIRCUIT, SEMICONDUCTOR APPARATUS, ELECTRONIC DEVICE, AND VEHICLE

(71) Applicant: ROHM CO., LTD., Kyoto (JP)

(72) Inventors: Mark Puno BUENAVIDEZ, Kyoto (JP); Joita ADRIAN, Kyoto (JP); Toru TAKUMA, Kyoto (JP)

(21) Appl. No.: 18/822,935

(22) Filed: Sep. 3, 2024

Related U.S. Application Data
(63) Continuation of application No. PCT/JP2023/001346, filed on Jan. 18, 2023.

(30) Foreign Application Priority Data
Mar. 4, 2022 (JP) 2022-033328

(51) Int. Cl. H02H 3/08; H02H 1/00

(52) U.S. Cl. CPC H02H 3/08; H02H 1/0007

(57) ABSTRACT

An overcurrent protection circuit, for example, comprises: an overcurrent detection unit configured to compare monitoring target current and an overcurrent detection threshold value; a current interruption unit configured to interrupt the monitoring target current when the monitoring target current reaches the overcurrent detection threshold value; an interruption cancellation unit configured to cancel the interruption of the monitoring target current at the elapse of a first time after the monitoring target current has reached the overcurrent detection threshold value; and a threshold control unit configured to lower the overcurrent detection threshold value at the elapse of the first time after the monitoring target current has reached the overcurrent detection threshold value.

### CROSS-REFERENCE TO RELATED APPLICATIONS

This nonprovisional application is a continuation application of International Patent Application No. PCT/JP2023/001346 filed on Jan. 18, 2023, which claims priority Japanese Patent Application No. 2022-033328 filed on Mar. 4, 2022, the entire contents of which are hereby incorporated by reference.

### TECHNICAL FIELD

The disclosure herein relates to an overcurrent protection circuit as well as to semiconductor apparatuses, electronic devices, and vehicles each including the overcurrent protection circuit.

### BACKGROUND ART

The present applicants have heretofore proposed a large number of novel technologies in relation to semiconductor apparatuses such as on-vehicle IPDs (Intelligent Power Device) (see, e.g., Patent Document 1).

### CITATION LIST

### Patent Literature

Patent Document 1: International Publication WO2017/187785

### BRIEF DESCRIPTION OF DRAWINGS

FIG. 1 is a diagram showing a configurational example of an electronic device equipped with a semiconductor apparatus;

FIG. 2 is a block circuit diagram showing an electrical structure of the semiconductor apparatus;

FIG. 3 is a chart showing behavior of an inrush current flowing upon start-up of a bulb lamp;

FIG. 4 is a diagram showing a configurational example of the overcurrent protection circuit;

FIG. 5 is a chart showing one example of overcurrent protective operation;

FIG. 6 is a chart showing lowering behavior of overcurrent detection threshold value; and

FIG. 7 is an appearance view showing one configurational example of a vehicle.

### DESCRIPTION OF EMBODIMENTS

### Electronic Device

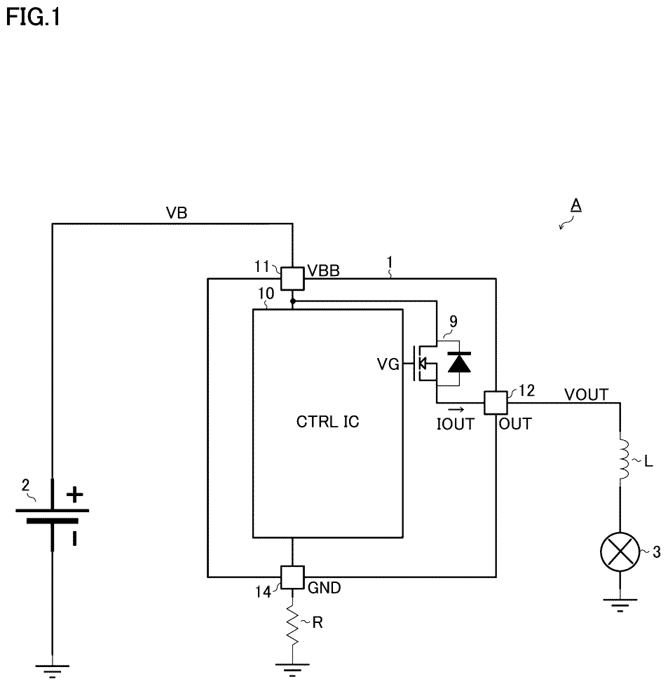

FIG. 1 is a diagram showing a configurational example of an electronic device equipped with a semiconductor apparatus. The electronic device A of this configurational example is provided with a semiconductor apparatus 1, a DC power supply 2, and a load 3.

The semiconductor apparatus 1 is a high-side switch (one type of IPD) configured to make conduction or interruption between the DC power supply 2 and the load 3. The semiconductor apparatus 1 is made up by integrating together a power MISFET (Metal Insulator Semiconductor Field Effect Transistor) 9 and a controller 10.

Also, the semiconductor apparatus 1 is equipped with a plurality of external electrodes as a means for establishing electrical connections with device external. Referring to the figure, the semiconductor apparatus 1 equipped with a drain electrode 11 (=equivalent to power supply electrode VBB), a source electrode 12 (=equivalent to output electrode OUT), and a reference voltage electrode 14 (=equivalent to ground electrode GND).

The power MISFET 9 is one example of insulated gate type power transistor (=output transistor), which functions as a high-side switch device operable to make conduction or interruption between the drain electrode 11 and the source electrode 12.

The controller 10 includes plural-type functional circuits to implement various functions. As an example, the plural-type functional circuits include a circuit configured to generate a gate control signal VG for drive control of the power MISFET 9 based on external electric signals.

The drain electrode 11 transmits power supply voltages VB to the drain of the power MISFET 9 and various circuits of the controller 10. The source electrode 12, being connected to the source of the power MISFET 9, transmits an output voltage VOUT and an output current IOUT to the load 3. In addition, signal lines (e.g., wire harness) laid down between the source electrode 12 and the load 3 generally entail an inductance component L (and resistance component). An input electrode 13 transmits an input voltage (=input signal IN) for driving of the controller 10. The reference voltage electrode 14 transmits a reference voltage (e.g., ground voltage) to the controller 10. It is noted that a resistor component R is generally entailed between the reference voltage electrode 14 and the ground terminal.

### Semiconductor Apparatus

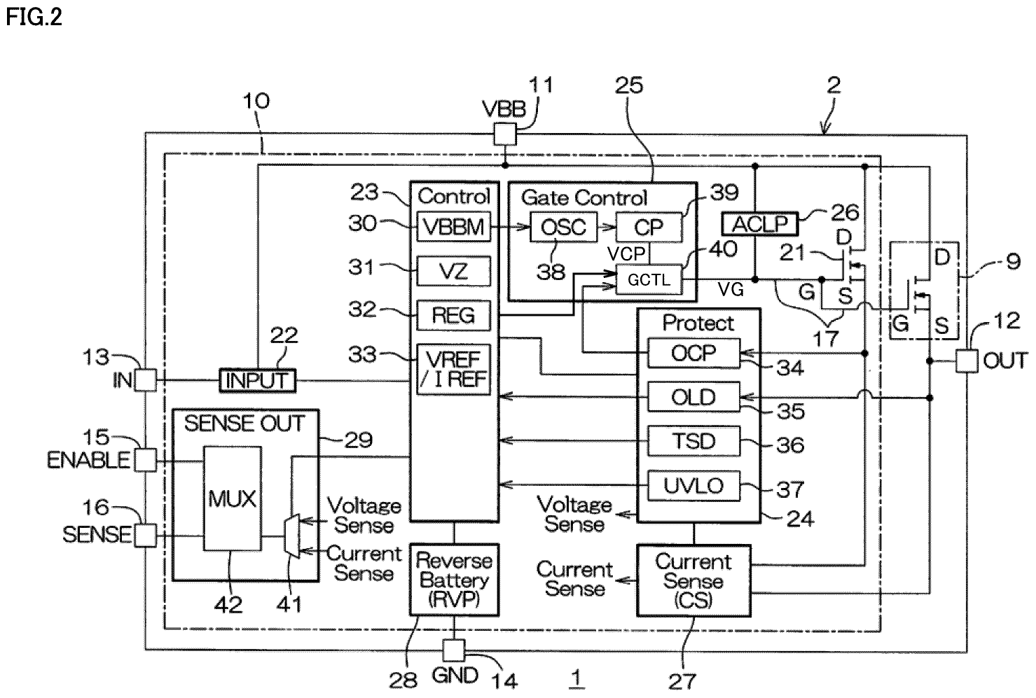

FIG. 2 is a block circuit diagram showing an electrical structure of the semiconductor apparatus 1 shown in FIG. 1. The following description will be made by taking, as an example, a case in which the semiconductor apparatus 1 is mounted on a vehicle. In addition, the semiconductor apparatus 1 is applicable, in terms of mounting onto vehicles, as a light source for bulb lamps or LED (Light Emitting Diode) lamps, or as a high-side switch for use in exerting conduction control over other types of electronic control devices.

The semiconductor apparatus 1 includes the drain electrode 11, the source electrode 12, the input electrode 13, the reference voltage electrode 14, an enable electrode 15, a sense electrode 16, a gate control line 17, the power MISFET 9, and the controller 10.

The drain electrode 11 (=power supply electrode VBB) is connected to the DC power supply 2. The drain electrode 11 provides the power MISFET 9 and the controller 10 with the power supply voltage VB. The power supply voltage VB may be within a range from 10 V to 20 V. Meanwhile, the source electrode 12 (=output electrode OUT) is connected to the load 3.

The input electrode 13 (=input electrode IN) may also be connected to an MCU (micro controller unit), a DC/DC converter, LDO (Low Drop Out) regulator or the like. The input electrode 13 provides the controller 10 with an input voltage. The input voltage may be within a range from 1 V to 10 V. The reference voltage electrode 14 is connected to a reference voltage line (ground terminal). The reference voltage electrode 14 provides the power MISFET 9 and the controller 10 with the reference voltage.

The enable electrode 15 may be connected to the MCU. Inputted to the enable electrode 15 are electrode signals functioning to validate or invalidate part or entirety of functions of the controller 10. The sense electrode 16 transmits, to device external, electric signals for use of sensing any abnormality of the controller 10. In addition, the sense electrode 16 may be pulled up or pulled down by a resistor.

A gate of the power MISFET 9 is connected to the controller 10 (particularly, a later-described gate control circuit 25) via the gate control line 17. The drain of the power MISFET 9 is connected to the drain electrode 11. The source of the power MISFET 9 is connected to the controller 10 (particularly, later-described current sensing circuit 27) and the source electrode 12.

The controller 10 includes a sensor MISFET 21, an input circuit 22, a current/voltage control circuit 23, a protection circuit 24, a gate control circuit 25, an active clamp circuit 26, a current sensing circuit 27, a power supply reversal protection circuit 28, and an abnormality sensing circuit 29.

A gate of the sensor MISFET 21 is connected to the gate control circuit 25. A drain of the sensor MISFET 21 is connected to the drain electrode 11. A source of the sensor MISFET 21 is connected to the current sensing circuit 27.

The input circuit 22 is connected to the input electrode 13 and the current/voltage control circuit 23. The input circuit 22 may include a Schmitt trigger circuit. The input circuit 22 works for waveform shaping of an electric signal applied to the input electrode 13. A signal generated by the input circuit 22 is inputted to the current/voltage control circuit 23.

The current/voltage control circuit 23 is connected to the protection circuit 24, the gate control circuit 25, the power supply reversal protection circuit 28, and the abnormality sensing circuit 29. The current/voltage control circuit 23 may include a logic circuit.

The current/voltage control circuit 23 generates various voltages in response to electric signals derived from the input circuit 22 and electric signals derived from the protection circuit 24. In this embodiment, the current/voltage control circuit 23 includes a drive voltage generation circuit 30, a first constant-voltage generation circuit 31, a second constant-voltage generation circuit 32, and a reference voltage/reference current generation circuit 33.

The drive voltage generation circuit 30 generates a drive voltage for use in driving the gate control circuit 25. The drive voltage may be set to a value obtained by subtracting a specified value from the power supply voltage VB. The drive voltage generation circuit 30 may also generate a drive voltage within a range of 5 V to 15 V obtained by subtracting 5 V from the power supply voltage VB. The drive voltage is inputted to the gate control circuit 25.

The first constant-voltage generation circuit 31 generates a first constant voltage for driving the protection circuit 24. The first constant-voltage generation circuit 31 may include a Zener diode or a regulator circuit (Zener diode in this case). The first constant voltage may be within a range of 1 V to 5 V. The first constant voltage is inputted to the protection circuit 24 (more specifically, later-described open load detection circuit 35 or the like).

The second constant-voltage generation circuit 32 generates a second constant voltage for driving the protection circuit 24. The second constant-voltage generation circuit 32 may include a Zener diode or a regulator circuit (regulator circuit in this case). The second constant voltage may be within a range of 1 V to 5 V. The second constant voltage is inputted to the protection circuit 24 (more specifically, later-described overheat protection circuit 36 and low-voltage malfunction suppression circuit 37).

The reference voltage/reference current generation circuit 33 generates a reference voltage and a reference current for various circuits. The reference voltage may be within a range of 1 V to 5 V. The reference current may be within a range of 1 mA to 1 A. The reference voltage and the reference current are inputted to various circuits. In a case where the various circuits include a comparator, the reference voltage and the reference current may be inputted to the comparator.

The protection circuit 24 is connected to the current/voltage control circuit 23, the gate control circuit 25, the abnormality sensing circuit 29, the source of the power MISFET 9, and the source of the sensor MISFET 21. The protection circuit 24 includes an overcurrent protection circuit 34, the open load detection circuit 35, the overheat protection circuit 36, and the low-voltage malfunction suppression circuit 37.

The overcurrent protection circuit 34 protects the power MISFET 9 from overcurrent. The overcurrent protection circuit 34 is connected to the gate control circuit 25 and the source of the sensor MISFET 21. The overcurrent protection circuit 34 may include a current monitor circuit. A signal generated by the overcurrent protection circuit 34 is inputted to the gate control circuit 25 (more specifically, later-described drive signal output circuit 40).

The open load detection circuit 35 detects a short-circuited state and an open state of the power MISFET 9. The open load detection circuit 35 is connected to the current/voltage control circuit 23 and the source of the power MISFET 9. A signal generated by the open load detection circuit 35 is inputted to the current/voltage control circuit 23.

The overheat protection circuit 36 monitors temperature of the power MISFET 9 to protect the power MISFET 9 from excessive temperature increases. The overheat protection circuit 36 is connected to the current/voltage control circuit 23. The overheat protection circuit 36 may include a temperature-sensitive device such as a temperature-sensitive diode or a thermistor. A signal generated by the overheat protection circuit 36 is inputted to the current/voltage control circuit 23.

The low-voltage malfunction suppression circuit 37 suppresses malfunction of the power MISFET 9 under a condition that the power supply voltage VB is lower than a specified value. The low-voltage malfunction suppression circuit 37 is connected to the current/voltage control circuit 23. A signal generated by the low-voltage malfunction suppression circuit 37 is inputted to the current/voltage control circuit 23.

The gate control circuit 25 controls on-and off-state of the power MISFET 9, as well as on-and off-state of the sensor MISFET 21. The gate control circuit 25 is connected to the current/voltage control circuit 23, the protection circuit 24, the gate of the power MISFET 9, and the gate of the sensor MISFET 21.

The gate control circuit 25 outputs a gate control signal VG to the gate control line 17 in response to an electric signal derived from the current/voltage control circuit 23 as well as to an electric signal derived from the protection circuit 24. The gate control signal VG is inputted via the gate control line 17 to the gate of the power MISFET 9 as well as to the gate of the sensor MISFET 21. More specifically, the gate control circuit 25 turns on/off the power MISFET 9 by controlling the gate control signal VG in response to the electric signal (input signal) applied to the input electrode 13.

The gate control circuit 25, more specifically, includes an oscillation circuit 38, a charge pump circuit 39 and a drive signal output circuit 40. The oscillation circuit 38 oscillates in response to an electric signal derived from the current/voltage control circuit 23 to generate a specified electric signal. An electric signal generated by the oscillation circuit 38 is inputted to the charge pump circuit 39. The charge pump circuit 39 generates a boost voltage VCP on a basis of an electric signal derived from the oscillation circuit 38. The boost voltage VCP generated by the charge pump circuit 39 is inputted to the drive signal output circuit 40.

The drive signal output circuit 40, which operates upon reception of the boost voltage VCP outputted from the charge pump circuit 39, generates a gate control signal VG in response to an electric signal derived from the protection circuit 24 (more specifically, overcurrent protection circuit 34). The gate control signal VG is inputted via the gate control line 17 to the gate of the power MISFET 9 and the gate of the sensor MISFET 21. The sensor MISFET 21 and the power MISFET 9 are controlled simultaneously by the gate control circuit 25.

The active clamp circuit 26 protects the power MISFET 9 from counter electromotive force. The active clamp circuit 26 is connected to the drain electrode 11, the gate of the power MISFET 9, and the gate of the sensor MISFET 21. The active clamp circuit 26 may include a plurality of diodes.

The active clamp circuit 26 may also include a plurality of diodes of mutual forward-bias connection. The active clamp circuit 26 may also include a plurality of diodes of mutual reverse-bias connection. The active clamp circuit 26 may also include a plurality of diodes of mutual forward-bias connection and a plurality of diodes of mutual reverse-bias connection.

The plurality of diodes may include a pn-junction diode, or a Zener diode, or a pn-junction diode and a Zener diode. The active clamp circuit 26 may also include a plurality of Zener diodes of mutual bias connection. The active clamp circuit 26 may also include a Zener diode and a pn-junction diode of mutual reverse-bias connection.

The current sensing circuit 27 senses currents flowing through the power MISFET 9 and the sensor MISFET 21. The current sensing circuit 27 is connected to the protection circuit 24, the abnormality sensing circuit 29, the source of the power MISFET 9, and the source of the sensor MISFET 21. The current sensing circuit 27 generates a current sensing signal in response to an electric signal (=output current IOUT) generated by the power MISFET 9 and an electric signal (=sense current ISNS identical in behavior to output current IOUT) generated by the sensor MISFET 21. The current sensing signal is inputted to the abnormality sensing circuit 29.

In a case where the DC power supply 2 is connected reverse, the power supply reversal protection circuit 28 protects the current/voltage control circuit 23 and the power MISFET 9 or the like from reverse voltage. The power supply reversal protection circuit 28 is connected to the reference voltage electrode 14 and the current/voltage control circuit 23.

The abnormality sensing circuit 29 monitors voltage of the protection circuit 24. The abnormality sensing circuit 29 is connected to the current/voltage control circuit 23, the protection circuit 24, and the current sensing circuit 27. Upon an abnormality (e.g., voltage fluctuation) occurring to any of the overcurrent protection circuit 34, the open load detection circuit 35, the overheat protection circuit 36, and the low-voltage malfunction suppression circuit 37, the abnormality sensing circuit 29 generates an abnormality sensing signal corresponding to a voltage of the protection circuit 24, and outputs the signal to external.

More specifically, the abnormality sensing circuit 29 includes a first multiplexer circuit 41 and a second multiplexer circuit 42. The first multiplexer circuit 41 includes two input ports, one output port, and one selective control input port. Connected to the input ports of the first multiplexer circuit 41 are the protection circuit 24 and the current sensing circuit 27, respectively. Connected to the output port of the first multiplexer circuit 41 is the second multiplexer circuit 42. Connected to the selective control input port of the first multiplexer circuit 41 is the current/voltage control circuit 23.

The first multiplexer circuit 41 generates abnormality sensing signals in response to an electric signal derived from the current/voltage control circuit 23, a voltage sensing signal derived from the protection circuit 24, and a current sensing signal derived from the current sensing circuit 27. The abnormality sensing signal generated by the first multiplexer circuit 41 is inputted to the second multiplexer circuit 42.

The second multiplexer circuit 42 includes two input ports and one output port. Connected to the input ports of the second multiplexer circuit 42 are the output port of the second multiplexer circuit 42 and the enable electrode 15, respectively. Connected to the output port of the second multiplexer circuit 42 is the sense electrode 16.

In a case where the MCU is connected to the enable electrode 15 and a pull-up or-down resistor is connected to the sense electrode 16, an on signal is inputted from the MCU to the enable electrode 15, and the abnormality sensing signal is extracted from the sense electrode 16. The abnormality sensing signal is converted into an electric signal by the resistor connected to the sense electrode 16. A status abnormality of the semiconductor apparatus 1 is detected based on this electric signal.

### Considerations About Overcurrent Protection Circuit

In the field of the semiconductor apparatus 1 such as IPDs dealing with large currents, adoptable as a control method for the overcurrent protection circuit 34 is the hiccup type one in which the semiconductor apparatus 1 (especially, power MISFET 9) is less likely to increase in temperature during overcurrent protective operation.

With the overcurrent protection circuit 34 given by a hiccup type one, when the output current IOUT has reached a specified overcurrent detection threshold value, the output current IOUT is interrupted and then after an elapse of a specified retry time (cool-down time), the interrupted state of the output current IOUT is canceled. It is noted that the above-described sequential hiccup control is repeated until the overcurrent state of the output current IOUT is canceled.

In this connection, the semiconductor apparatus 1 is mountable on a vehicle as an on-vehicle IPD aimed at supplying electric power to various loads 3. In such cases, resistive, inductive, or capacitive loads 3 (bulbs of vehicles etc.) may be connected to the semiconductor apparatus 1.

For example, a bulb (bulb lamps etc.) of a vehicle that has started up in a low-temperature state requires a high amount of inrush current to heat a filament. That is, since temperature and resistance values of the filament are considerably low, a large amount of inrush current flows immediately after lightening of the bulb. Thereafter, as the temperature and resistance values of the filament increases on and on, the current flowing through the bulb reaches a stable point. At this time point, the resistance value of the filament comes to a value far lower than that at the start-up time.

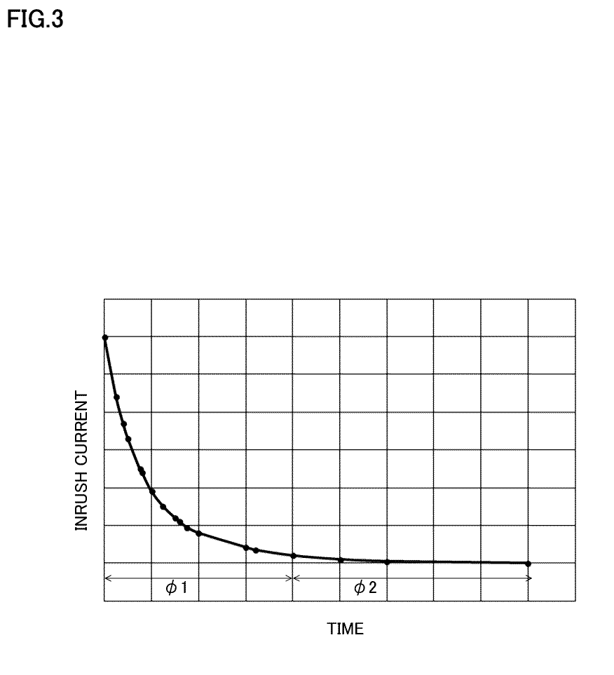

FIG. 3 is a chart showing behavior (transient response characteristic) of an inrush current flowing upon start-up of a bulb lamp (e.g., 55 W halogen lamp). It is noted that the horizontal axis represents time, and the vertical axis represents the inrush current.

As shown in this figure, the behavior of the inrush current flowing at a start-up of the bulb lamp is classified into two phases, a first phase φ1 (=inrush phase) in which the current value abruptly decreases or attenuates along with time elapse, and a second phase φ (=statically determinate phase) in which the current value becomes generally constant without depending on time elapse. It is noted that an initial value of the inrush current flowing in the first phase φ1 becomes several times larger than that of the inrush current flowing in the second phase φ2.

In order that the above-mentioned inrush current is permitted so as not to cause any obstacle to start-up of the bulb lamp, the overcurrent detection threshold value IOCD of the overcurrent protection circuit 34 needs to be set to a very large current value (>initial value of inrush current flowing in the first phase φ1).

However, such a large current is needed only for start-up of the bulb lamp, and is excessively large as compared with currents flowing under steady operations of the bulb lamp. Therefore, when the output current IOUT has fallen into an overcurrent state, traditional hiccup control would involve not a few times of repeated flows of instantaneous large currents. Accordingly, since generated heat of the semiconductor apparatus 1 (especially, power MISFET 9) accumulates on and on along with time elapse, there is a possibility that the semiconductor apparatus 1 may be degraded in reliability.

Meanwhile, simply lowering the overcurrent detection threshold value IOCD would cause the hiccup control to be activated upon a start-up of the bulb lamp. With the traditional hiccup control, since the retry time is set to a fixed value (e.g., several tens ms), there may occur an obstacle to start-up of the bulb lamp.

Hereinafter, in view of the above-described discussions, there will be proposed an overcurrent protection circuit 34 capable of ensuring an inrush current and fulfilling proper overcurrent protection at the same time.

### Overcurrent Protection Circuit

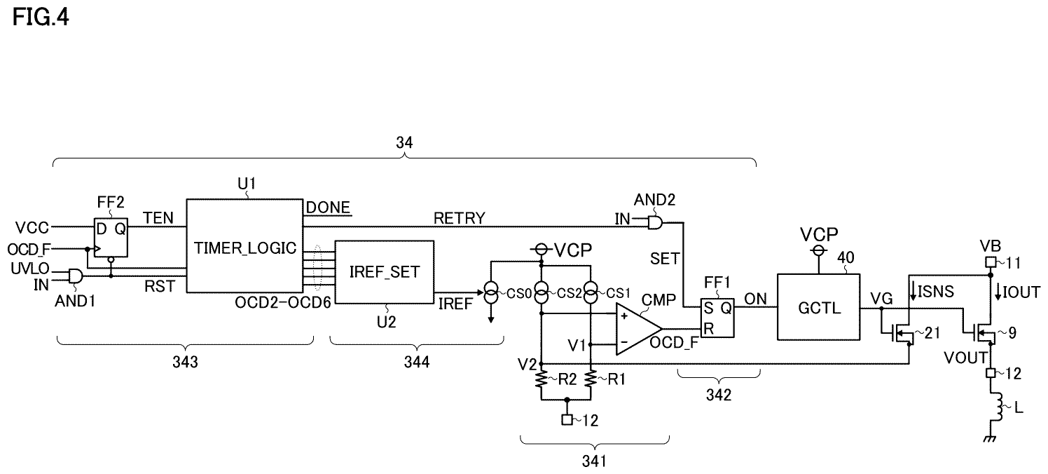

FIG. 4 is a diagram showing a configurational example of the overcurrent protection circuit 34. The overcurrent protection circuit 34 of this configurational example is a kind of abnormality protection circuit which monitors, as its monitoring target current, the output current IOUT flowing through the power MISFET 9 and which limits the output current IOUT by hiccup control.

For example, the overcurrent protection circuit 34 may include an overcurrent detection unit 341, a current interruption unit 342, an interruption cancellation unit 343, and a threshold control unit 344.

The overcurrent detection unit 341 generates an overcurrent detection signal OCD_F by comparing the output current IOUT and the overcurrent detection threshold value IOCD with each other. Referring to the figure, the overcurrent detection unit 341 includes current sources CS1 and CS2, resistors R1 and R2, and a comparator CMP.

First terminals of the current sources CS1 and CS2, respectively, are both connected to an application terminal of the boost voltage VCP. A second terminal of the current source CS1 and a first terminal of the resistor RI are both connected to an inverted input terminal (−) of the comparator CMP as an application terminal of the first voltage V1 (=equivalent to overcurrent detection threshold voltage). A second terminal of the current source CS2 and a second terminal of the resistor R2 are both connected to a noninverting input terminal (+) of the comparator CMP and a source of the sensor MISFET 21 as application terminals of a second voltage V2 (=equivalent to sense voltage). The second terminals of the resistors R1 and R2 are both connected to the source electrode 12 (output electrode).

The current sources CS1 and CS2 each generate a reference current IREF (e.g., later-described mirror current of the reference current IREF flowing through the current source CS0) which is to be set by the threshold control unit 344. Accordingly, it results that V1=IREF×R1 and V2=(IREF+ISNS)×R2.

The comparator CMP generates an overcurrent detection signal OCD_F by comparing a first voltage V1 inputted to the noninverting input terminal (−) and an overcurrent detection signal inputted to the noninverting input terminal (+) with each other. Accordingly, when V1>V2, the overcurrent detection signal OCD_F goes low (=logical level under an overcurrent undetected condition), and when v1<V2, goes high (=logical level under an overcurrent detected condition).

The current interruption unit 342 interrupts the output current IOUT when the output current IOUT has reached the overcurrent detection threshold value IOCD. Referring to the figure, the current interruption unit 342 includes an RS flip-flop FF1.

The RS flip-flop FF1 switches over the logical level of an on signal ON outputted from an output terminal (q) in response to a set signal SET inputted to a set terminal(S) and the overcurrent detection signal OCD_F inputted to a reset terminal (R). For example, the on signal ON is set to high with a pulse edge (e.g., rising edge) of the set signal SET used as a trigger, and reset to low with a pulse edge (e.g., rising edge) of the overcurrent detection signal OCD_F used as a trigger.

The drive signal output circuit 40 generates a gate control signal VG in response to an on signal ON outputted from the overcurrent protection circuit 34. For example, the gate control signal VG goes high (=VCP) when the on signal ON is high, and goes low (=VOUT) when the on signal ON is low.

The interruption cancellation unit 343 cancels the interruption of the output current IOUT at an elapse of the retry time T1 (=equivalent to first time) since the output current IOUT has reached the overcurrent detection threshold value IOCD. Referring to the figure, the interruption cancellation unit 343 includes a D flip-flop FF2, a timer logic U1, and AND processors AND1 and AND2.

The D flip-flop FF2 goes operative when the reset signal RST is high (=logical level under a reset canceled condition). For example, the D flip-flop FF2 sets a timer enable signal TEN outputted from an output terminal (Q) to high level by latching a high-level signal (e.g., power supply voltage VCC) inputted to a data input terminal (D) with a pulse edge (e.g., rising edge) of the overcurrent detection signal OCD_F inputted to a clock end (>) used as a trigger. On the other hand, when the reset signal RST is low (=logical level at a reset time), the D flip-flop FF2 goes inoperative, with the timer enable signal TEN being reset to low level.

The timer logic U1 goes operative when the timer enable signal TEN is high (=logical level under an enabled condition). For example, the timer logic U1, including an oscillator and a counter, generates various control signals (timer logic signals OCD2 to OCD6, a retry signal RETRY, and a count-completed signal DONE) necessary for novel hiccup control (detailed later). It is noted that when the reset signal RST is low (=logical level at a reset time), the foregoing various control signals are reset to their initial values, respectively. Also, the timer logic U1 may also accept an input of the overcurrent detection signal OCD_F.

The AND processor AND1 generates a reset signal RST by logical AND operation of a low-voltage malfunction suppression signal UVLO and an input signal IN. Accordingly, the reset signal RST goes low when at least one of the low-voltage malfunction suppression signal UVLO and the input signal IN is low, and the reset signal RST goes high when both the low-voltage malfunction suppression signal UVLO and the input signal IN are high.

The AND processor AND2 generates a set signal SET by logical AND operation of the input signal IN and the retry signal RETRY. Accordingly, the set signal SET goes low when at least one of the input signal IN and the retry signal RETRY is low, and the set signal SET goes high when both the input signal IN and the retry signal RETRY are high.

The threshold control unit 344 lowers the overcurrent detection threshold value IOCD when the retry time T1 has elapsed since a reach of the output current IOUT to the overcurrent detection threshold value IOCD. Referring to the figure, the threshold control unit 344 includes a reference current setter U2 and a current source CS0.

The reference current setter U2 sets a reference current IREF in response to the timer logic signals OCD2 to OCD6.

The current source CS0, which is connected between the application terminal of the boost voltage VCP and a fixed potential terminal, generates a reference current IREF set by the reference current setter U2.

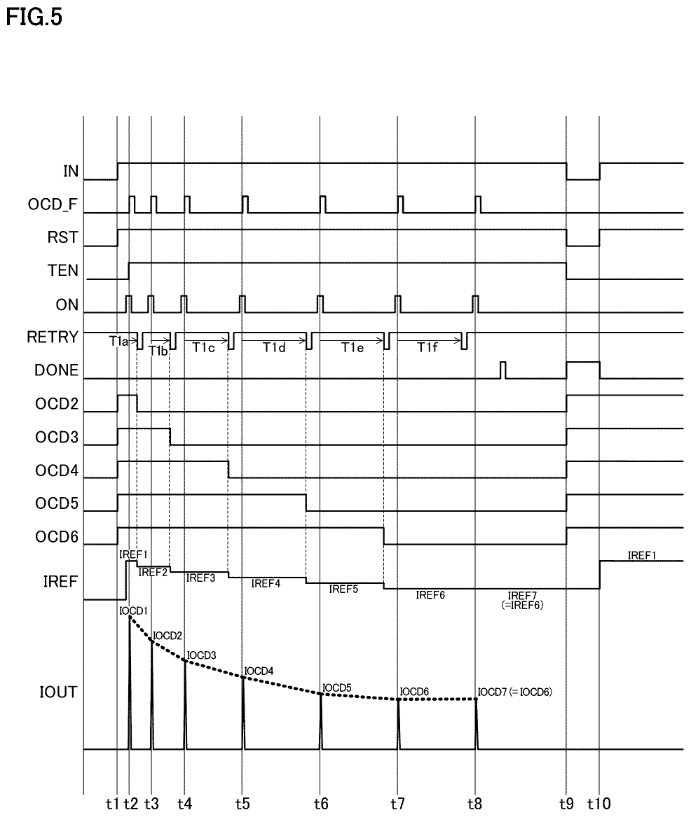

FIG. 5 is a chart showing one example of overcurrent protective operation. Depicted in the chart are, as in order starting from the uppermost, input signal IN, overcurrent detection signal OCD_F, reset signal RST, timer enable signal TEN, on signal ON, retry signal RETRY, count-completed signal DONE, timer logic signals OCD2 to OCD6, reference current IREF, and output current IOUT.

In this chart, it is assumed that there has occurred a ground fault (=short circuit fault to a ground terminal or a low-potential terminal) at the source electrode 12, and that the output current IOUT has fallen into an overcurrent state.

When the input signal IN rises to high at time t1, the reset signal RST also rises to high resultantly. Accordingly, both the D flip-flop FF2 and the timer logic U1 fall into a reset-canceled state. However, at this time point, the timer enable signal TEN is low. Accordingly, the timer logic U1 has not yet started operation, and various control signals are at their initial values, respectively (RETRY=H, DONE=L, OCD2=OCD3=OCD4=OCD5=OCD6=H).

In addition, when all the timer logic signals OCD2 to OCD6 are high, the reference current IREF is set to a first set value IREF1 (=largest value out of plural candidate values). In other words, the overcurrent detection threshold value IOCD is set to a first set value IOCD1 (=largest value out of plural candidate values).

Thereafter, as the on signal ON is set to high, causing the power MISFET 9 to be turned on, there flows an excessive output current IOUT due to a ground fault of the source electrode 12. Accordingly, at time t2, the output current IOUT reaches the first set value IOCD1, so that the overcurrent detection signal OCD_F rises high. As a result, the on signal ON is reset to low, causing the power MISFET 9 to be turned off, with the output current IOUT interrupted.

Further, when the overcurrent detection signal OCD_F rises high, the timer enable signal TEN is set to high, causing the timer logic U1 to go operative. More specifically, the oscillator and the counter contained in the timer logic U1 go operative, where counting of the retry time T1 is started. It is noted that when the overcurrent detection signal OCD_F goes high for the first time, the retry time T1 is set to a first set value T1a (=shortest value out of plural candidate values, e.g., several ms).

When the retry time T1 (=T1a) has elapsed since rising-high of the overcurrent detection signal OCD_F, the timer logic U1 makes the retry signal RETRY (and therefore set signal SET as well) once fall to low and thereafter rise to high once again.

Further, the timer logic U1 makes the timer logic signal OCD2 fall to low in synchronization with the above-described pulse drive of the retry signal RETRY. In addition, on condition that the timer logic signal OCD2 is low and moreover the timer logic signals OCD3 to OCD6 are high, the reference current IREF is set to a second set value IREF2 (=a value one-step smaller than the foregoing first set value IREF1). In other words, the overcurrent detection threshold value IOCD is lowered from the first set value IOCD1 to the second set value IOCD2.

Thereafter, when the on signal ON is set to high so that the power MISFET 9 is turned on, interruption of the output current IOUT is canceled. In this case, on condition that the overcurrent state of the output current IOUT has not been canceled, an excessive output current IOUT flows once again. Accordingly, at time t3, the output current IOUT reaches the second set value IOCD2, so that the overcurrent detection signal OCD_F rises to high. As a result, the on signal ON is reset to low, causing the power MISFET 9 to be turned off, with a result that the output current IOUT is interrupted.

Also, upon receiving another rise to high of the overcurrent detection signal OCD_F, the timer logic U1 resumes counting of the retry time T1. In addition, when the rise of the overcurrent detection signal OCD_F is the second-time one, the retry time T1 is set to a second set value T1b longer than the first set value T1a. That is, the smaller the overcurrent detection threshold value IOCD, the longer the retry time T1.

When the retry time T1 (=T1b) has elapsed since a rise to high of the overcurrent detection signal OCD_F, the timer logic U1, as in the foregoing case, once makes the retry signal RETRY (and therefore set signal SET as well) fall to low and thereafter makes the signal rise to high again.

Further, the timer logic U1 makes the logic signal OCD3 fall to low in synchronization with the above-mentioned pulse drive of the retry signal RETRY. It is noted that when the timer logic signals OCD2 and OCD3 are low while the timer logic signals OCD4 to OCD6 are high, the reference current IREF is set to a third set value IREF3 (=a value one-step smaller than the foregoing second set value IREF2). In other words, the overcurrent detection threshold value IOCD is lowered from the second set value IOCD2 to a third set value IOCD3.

Also after this on, as described above, the overcurrent protective operation by hiccup control is continued under the condition that the retry time T1 and the overcurrent detection threshold value IOCD are changed.

At time t4, when the output current IOUT has reached the third set value IOCD3, the retry time T1 is set to the third set value T1c (>T1b). Then, when counting of the retry time T1 (=T1c) has been completed, the retry signal RETRY is driven in pulses and moreover the timer logic signal OCD4 is made to fall to low, so that the reference current IREF is set to a fourth set value IREF4 (<IREF3). In other words, the overcurrent detection threshold value IOCD is lowered to the fourth set value IOCD4 (<IOCD3).

At time t5, when the output current IOUT has reached the fourth set value IOCD4, the retry time T1 is set to a fourth set value T1d (>T1c). Then, when counting of the retry time T1 (=T1d) has been completed, the retry signal RETRY is driven in pulses and moreover the timer logic signal OCD5 is made to fall to low, so that the reference current IREF is set to a fifth set value IREF5 (<IREF4). In other words, the overcurrent detection threshold value IOCD is lowered to the fifth set value IOCD5 (<IOCD4).

At time t6, when the output current IOUT has reached the fifth set value IOCD5, the retry time T1 is set to a fifth set value T1e (>T1d). Then, when counting of the retry time T1 (=T1e) has been completed, the retry signal RETRY is driven in pulses and moreover the timer logic signal OCD6 is made to fall to low, so that the reference current IREF is set to a sixth set value IREF6 (<IREF5). In other words, the overcurrent detection threshold value IOCD is lowered to the sixth set value IOCD6 (<IOCD5).

At time t7, when the output current IOUT has reached the sixth set value IOCD6, the retry time T1 is set to a sixth set value T1f (>T1e). Then, when counting of the retry time T1 (=T1f) has been completed, the retry signal RETRY is driven in pulses and moreover the reference current IREF is set to a seventh set value IREF7 (=IREF6). In other words, the overcurrent detection threshold value IOCD is set to the seventh set value IOCD7 (=IOCD6).

At time t8, when the output current IOUT has reached the seventh set value IOCD7 and moreover a seventh pulse has risen in the overcurrent detection signal OCD_F, the timer logic U1 drives pulses for the count-completed signal DONE.

For example, the current interruption unit 342 may well latch the on signal ON at low level with a pulse edge of the count-completed signal DONE used as a trigger. More specifically, a latch circuit operable to accept input of a count-completed signal DONE may be inserted between the RS flip-flop FF1 and the drive signal output circuit 40, or a similar latch function may be incorporated at the input stage of the drive signal output circuit 40.

With such a configuration adopted, when a number of interruptions of the output current IOUT has reached a specified value, the output current IOUT can be unlatched. Thus, it becomes implementable to enhance reliability of the semiconductor apparatus 1.

In addition, as shown by time t9 to t10, making the input signal IN fall to low level causes the reset signal RST to fall to low level. Accordingly, the whole operating state of the timer logic U1 is completely reset. That is, various control signals (timer logic signals OCD2 to OCD6, retry signal RETRY, and count-completed signal DONE) generated by the timer logic U1 are reset to their respective initial values, with a result that the off-latch state of the output current IOUT is canceled.

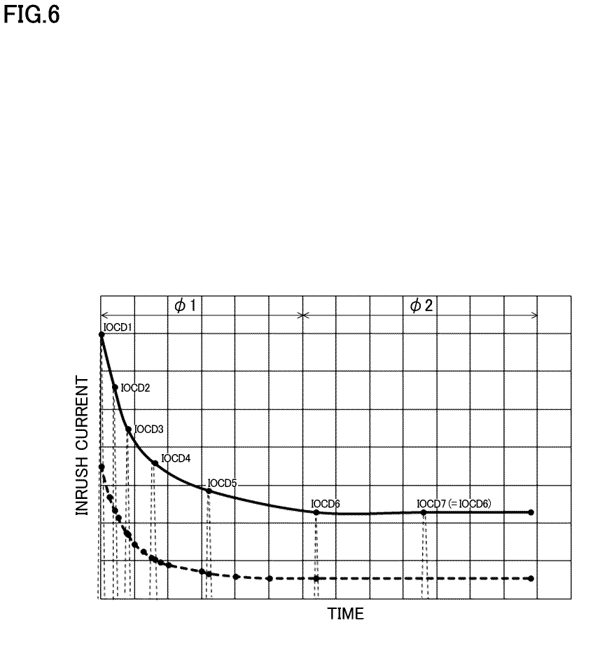

FIG. 6 is a chart showing lowering behavior of the overcurrent detection threshold value IOCD. Solid line and thin broken line in this figure denote the overcurrent detection threshold value IOCD and the output current IOUT (as in FIG. 5). Also, broken line in this figure denotes inrush current of the bulb lamp (as in FIG. 3).

In the above-described novel hiccup control, the overcurrent detection threshold value IOCD that is set for every retry may appropriately be lowered stepwise in accordance with behavior of the inrush current flowing through the bulb lamp upon its start-up. Referring to the figure, the overcurrent detection threshold value IOCD is lowered a total of six times while providing intervals of properly set retry time T1 so as to agree with the behavior of the inrush current flowing upon start-up of the bulb lamp.

In addition, as described above, the behavior of the inrush current flowing upon start-up of the bulb lamp is classified into two phases, a first phase φ1 (=inrush phase) in which the current value abruptly decreases or attenuates along with time elapse and a second phase φ2 (=statically determinate phase) in which the current value keeps generally constant without depending on time elapse.

In the first phase φ1, four times of retry are executed since first-time detection of an overcurrent state of the output current IOUT. The overcurrent detection threshold value IOCD is lowered at each retry in accordance with the inrush current having a specified attenuation coefficient (e.g., 20%) (IOCD1→IOCD2→IOCD3→IOCD4→IOCD5).

Meanwhile, in the second phase φ2, it is predicted that the load of the bulb lamp settles to a steady bias state. Therefore, two times of retry are executed with the overcurrent detection threshold value IOCD kept as it is (IOCD6, IOCD7).

As described above, with a configuration in which the overcurrent detection threshold value IOCD is lowered on and on in accordance with the behavior of the inrush current flowing through the bulb lamp upon its start-up, proper overcurrent protection can be applied even when a bulb lamp of a wattage higher than assumed is removably set up.

More specifically, immediately after start-up of the bulb lamp, hiccup control is carried out with shorter retry intervals while permitting larger inrush currents. Therefore, the filament of the bulb lamp can be heated promptly.

Meanwhile, around a time when the bulb lamp comes to a steady state, the overcurrent detection threshold value IOCD has been lowered enough, and moreover the retry intervals have also been prolonged. Accordingly, even when interruption and cancellation of the output current IOUT based on hiccup control are continuously repeated, generated heat of the semiconductor apparatus 1 (especially, power MISFET 9) becomes less likely to accumulate. Thus, it becomes implementable to enhance the reliability of the semiconductor apparatus 1.

### First Modification

In the above-described hiccup control, the overcurrent detection threshold value IOCD is never lowered from its initial value unless the output current IOUT has reached the initial value (=first set value IOCD1) of the overcurrent detection threshold value IOCD so that the overcurrent protective operation is activated. Also, even in cases where several times of retry are executed with the overcurrent protective operation applied based on hiccup control, the overcurrent detection threshold value IOCD may be kept to the end from being lowered when the output current IOUT has decreased after the several times of retry.

This being the case, as a modification of hiccup control, it is allowable that the overcurrent detection threshold value IOCD is lowered not only when the retry time T1 has elapsed since a reach of the output current IOUT to the overcurrent detection threshold value IOCD, but also when an interval time T2 (=equivalent to second time) has elapsed without reaching of the output current IOUT to the overcurrent detection threshold value IOCD since a start-up of the overcurrent protection circuit 34, or when the interval time T2 has elapsed without reaching of the output current IOUT to the overcurrent detection threshold value IOCD since a lowering of the overcurrent detection threshold value IOCD.

In addition, as to the interval time T2, as in the case of retry time T1, it may well be set that the smaller the overcurrent detection threshold value IOCD, the longer the interval time T2.

### Second Modification

In the above-described hiccup control, the retry time T1 and the overcurrent detection threshold value IOCD are set in accordance with the inrush current of the bulb lamp. As a modification resulting from extension of the foregoing setting of the retry time T1 and the overcurrent detection threshold value IOCD, at least one of the retry time T1 and the overcurrent detection threshold value IOCD may be adjusted in response to a temperature Tj of the power MISFET 9 or a temperature difference ΔTj between the power MISFET 9 and the controller 10 (current/voltage control circuit 23 etc.).

More specifically, the higher the temperature Tj or the temperature difference ΔTj is, the more the retry time T1 may be prolonged or the more the overcurrent detection threshold value IOCD may be lowered. Thus, according to the hiccup control to which temperature information has been added, more proper overcurrent protection can be applied, so that the reliability of the semiconductor apparatus 1 can further be enhanced.

### Application to Vehicles

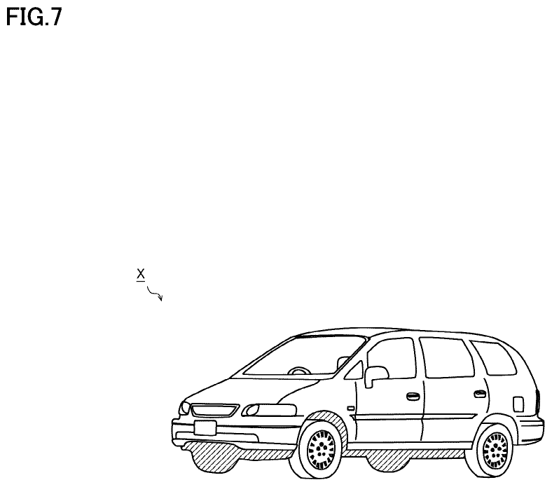

FIG. 7 is a appearance view showing one configurational example of a vehicle. Mounted on the vehicle X of this configurational example are a variety of electronic devices that are operative under electric power supply from batteries.

Included in the vehicle X are, in addition to engine vehicles, electric vehicles (BEV (battery electric vehicles), HEVs (hybrid electric vehicles), PHEVs/PHVs (plug-in hybrid electric vehicles/plug-in hybrid vehicles), or FCEVs/FCVs (xEVs such as fuel cell electric vehicles/fuel cell vehicles)).

In addition, the above-described semiconductor apparatus 1 is incorporable into any of electronic devices that are mounted on the vehicle X.

### Summary

The various embodiments described hereinabove will be described summationally below.

For example, the overcurrent protection circuit disclosed herein includes: an overcurrent detection unit configured to compare monitoring target current and an overcurrent detection threshold value; a current interruption unit configured to interrupt the monitoring target current when the monitoring target current reaches the overcurrent detection threshold value; an interruption cancellation unit configured to cancel the interruption of the monitoring target current at the elapse of a first time after the monitoring target current has reached the overcurrent detection threshold value; and a threshold control unit configured to lower the overcurrent detection threshold value at the elapse of the first time after the monitoring target current has reached the overcurrent detection threshold value (first configuration).

In the overcurrent protection circuit according to the first configuration, it is also allowable that the smaller the overcurrent detection threshold value becomes, the longer the first time becomes (second configuration).

In the overcurrent protection circuit according to the first or second configuration, it is also allowable that the current interruption unit unlatches the monitoring target current when a number of interruptions of the monitoring target current has reached a specified value (third configuration).

In the overcurrent protection circuit according to any one of the first to third configurations, it is also allowable that the threshold control unit lowers the overcurrent detection threshold value not only when the first time has elapsed since a reach of the monitoring target current to the overcurrent detection threshold value, but also when a second time has elapsed without reaching of the monitoring target current to the overcurrent detection threshold value since a start-up of the overcurrent protection circuit, or when the second time has elapsed without reaching of the monitoring target current to the overcurrent detection threshold value since a lowering of the overcurrent detection threshold value (fourth configuration).

In the overcurrent protection circuit according to the fourth configuration, it is also allowable that the smaller the overcurrent detection threshold value becomes, the longer the second time becomes (fifth configuration).

In the overcurrent protection circuit according to any one of the first to fifth configurations, it is also allowable that the monitoring target current is an output current flowing through an output transistor (sixth configuration).

In the overcurrent protection circuit according to the sixth configuration, it is also allowable that at least one of the first time and the overcurrent detection threshold value is adjusted in response to a temperature of the output transistor or a temperature difference between the output transistor and the controller (seventh configuration).

For example, the semiconductor apparatus disclosed herein is configured to include the output transistor, and the overcurrent protection circuit according to the sixth or seventh configuration (eighth configuration).

Also, for example, the electronic device disclosed herein is configured to include the semiconductor apparatus according to the eighth configuration (ninth configuration).

Also, for example, the vehicle disclosed herein is configured to include the electronic device according to the ninth configuration (tenth configuration).

According to the disclosure herein, there can be provided an overcurrent protection circuit, as well as semiconductor apparatuses, electronic devices and vehicles using the overcurrent protection circuit, capable of fulfilling the ensuring of the inrush current and proper overcurrent protection at the same time.

### Other Modifications

It should be noted that various technical features disclosed herein may be embodied not only as in the above-described embodiment but also as changed or modified in various ways without departing the gist of the disclosure's technical creation. That is, the above-described embodiment should be construed as not being limitative but being an exemplification at all points. The technical scope of the disclosure should be defined by the appended claims, and it should be construed that all changes and modifications equivalent in sense and scope to the appended claims are included in the technical scope of the disclosure.

1. An overcurrent protection circuit comprising:
an overcurrent detection unit configured to compare monitoring target current and an overcurrent detection threshold value with each other;
a current interruption unit configured to interrupt the monitoring target current when the monitoring target current has reached the overcurrent detection threshold value;
an interruption cancellation unit configured to cancel an interruption of the monitoring target current when a first time has elapsed since a reach of the monitoring target current to the overcurrent detection threshold value; and
a threshold control unit configured to lower the overcurrent detection threshold value when the first time has elapsed since a reach of the monitoring target current to the overcurrent detection threshold value.

2. The overcurrent protection circuit according to claim 1, wherein
the smaller the overcurrent detection threshold value becomes, the longer the first time becomes.

3. The overcurrent protection circuit according to claim 1, wherein
the current interruption unit unlatches the monitoring target current when a number of interruptions of the monitoring target current has reached a specified value.

4. The overcurrent protection circuit according to claim 1, wherein
the threshold control unit lowers the overcurrent detection threshold value not only when the first time has elapsed since a reach of the monitoring target current to the overcurrent detection threshold value, but also when a second time has elapsed without reaching of the monitoring target current to the overcurrent detection threshold value since a start-up of the overcurrent protection circuit, or when the second time has elapsed without reaching of the monitoring target current to the overcurrent detection threshold value since a lowering of the overcurrent detection threshold value.

5. The overcurrent protection circuit according to claim 4, wherein
the smaller the overcurrent detection threshold value becomes, the longer the second time becomes.

6. The overcurrent protection circuit according to claim 1, wherein
the monitoring target current is an output current flowing through an output transistor.

7. The overcurrent protection circuit according to claim 6, wherein
at least one of the first time and the overcurrent detection threshold value is adjusted in response to a temperature of the output transistor or a temperature difference between the output transistor and the controller.

8. A semiconductor apparatus comprising:
the output transistor; and
the overcurrent protection circuit according to claim 6.

9. An electronic device comprising
the semiconductor apparatus according to claim 8.

10. A vehicle comprising
the electronic device according to claim 9.
